(19) United States
(12) Patent Application Publication
(10) Pub. No.: US 2021/0302574 A1
(43) Pub. Date: Sep. 30, 2021

(54) OBJECT DETECTION SYSTEM AND OBJECT DETECTION DEVICE

(71) Applicant: AISIN SEIKI KABUSHIKI KAISHA, Kariya-shi (JP)

(72) Inventors: Ippei Sugae, Kariya-shi (JP); Hisashi Inaba, Kariya-shi (JP)

(73) Assignee: AISIN SEIKI KABUSHIKI KAISHA, Kariya-shi (JP)

(21) Appl. No.: 17/199,983

(22) Filed: Mar. 12, 2021

(30) Foreign Application Priority Data
Mar. 30, 2020 (JP) 2020-061270

(51) Int. Cl. G01S 15/10; G01S 15/931; G01S 7/527; G01S 7/524

(52) U.S. Cl. CPC G01S 15/104; G01S 7/524; G01S 7/527; G01S 15/931

(57) ABSTRACT

An object detection system includes: a plurality of object detection devices. Each of the plurality of object detection devices includes a transmission unit that transmits, substantially simultaneously with the other object detection devices, a transmission wave encoded based on one or a combination of two or more surges of a plurality of surges which are respectively applied with frequency modulations based on a plurality of chirp signals whose frequencies change in patterns different from one another, the one or the combination of two or more surges being different from those used in the other object detection devices, a reception unit that receives a reception wave that is the transmission wave returned in response to reflection by an object, and a detection processing unit that detects information related to the object based on information acquired as a result of transmission and reception of the transmission wave and the reception wave.

### CROSS REFERENCE TO RELATED APPLICATIONS

This application is based on and claims priority under 35 U.S.C. § 119 to Japanese Patent Application 2020-061270, filed on Mar. 30, 2020, the entire content of which is incorporated herein by reference.

### TECHNICAL FIELD

This disclosure relates to an object detection system and an object detection device.

### BACKGROUND DISCUSSION

In the related art, there is known a technique of detecting information related to an object, such as a distance to the object, by transmitting an ultrasonic wave as a transmission wave and receiving a reception wave that is the transmission wave reflected by and returned from the object (Reference 1 (WO 2011/102130)).

In the related art as described above, a system provided with a plurality of object detection devices for detecting the information related to the object may be implemented. In such a system, in order to detect the information related to the object in more detail, transmission waves may be transmitted substantially simultaneously (simultaneously and concurrently) from each of the plurality of object detection devices. In this case, in order to prevent interference and the like, it is desirable to improve identifiability of the transmission waves.

A need thus exists for an object detection system and an object detection device which are not susceptible to the drawback mentioned above.

### SUMMARY

An object detection system as an example of this disclosure includes: a plurality of object detection devices, in which each of the plurality of object detection devices includes a transmission unit that transmits, substantially simultaneously with the other object detection devices, a transmission wave encoded based on one or a combination of two or more surges of a plurality of surges which are respectively applied with frequency modulations based on a plurality of chirp signals whose frequencies change in patterns different from one another, the one or the combination of two or more surges being different from those used in the other object detection devices, a reception unit that receives a reception wave that is the transmission wave returned in response to reflection by an object, and a detection processing unit that detects information related to the object based on information acquired as a result of transmission and reception of the transmission wave and the reception wave.

An object detection system as another example of this disclosure includes a plurality of object detection devices, in which each of the plurality of object detection devices includes a transmission unit that transmits, substantially simultaneously with the other object detection devices, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from those used in the other object detection devices, a reception unit that receives a reception wave that is the transmission wave returned in response to reflection by an object, and a detection processing unit that detects information related to the object based on information acquired as a result of transmission and reception of the transmission wave and the reception wave.

An object detection device as another example of this disclosure includes: a transmission unit that transmits, substantially simultaneously with another object detection device, a transmission wave encoded based on one or a combination of two or more surges of a plurality of surges which are respectively applied with frequency modulations based on a plurality of chirp signals whose frequencies change in patterns different from one another, the one or the combination of two or more surges being different from that used in the another object detection device, a reception unit that receives a reception wave that is the transmission wave returned in response to reflection by an object, and a detection processing unit that detects information related to the object based on information acquired as a result of transmission and reception of the transmission wave and the reception wave.

An object detection device as another example of this disclosure includes: a transmission unit that transmits, substantially simultaneously with another object detection device, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from that used in the another object detection device, a reception unit that receives a reception wave that is the transmission wave returned in response to reflection by an object, and a detection processing unit that detects information related to the object based on information acquired as a result of transmission and reception of the transmission wave and the reception wave.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view showing an example of an appearance of a vehicle including an object detection system according to a first embodiment when viewed from above;

FIG. 2 is a schematic block diagram showing an example of schematic hardware configurations of an electronic control unit (ECU) and an object detection device of the object detection system according to the first embodiment;

FIG. 3 is a schematic diagram showing an example of an outline of a technique used by the object detection device according to the first embodiment to detect a distance to an object;

FIG. 4 is a schematic block diagram showing an example of a detailed configuration of the object detection device according to the first embodiment;

FIG. 5 is a schematic diagram showing an example of a first chirp signal according to the first embodiment;

FIG. 6 is a schematic diagram showing an example of a second chirp signal according to the first embodiment;

FIG. 7 is a schematic diagram showing an example of a modulation pattern corresponding to identification information according to the first embodiment;

FIG. 8 is a schematic flowchart showing an example of a series of processing performed by the object detection system according to the first embodiment to detect a distance to the object;

FIG. 9 is a schematic diagram showing an example of a modulation method according to a second embodiment;

FIG. 10 is a schematic diagram showing an example of a modulation pattern corresponding to identification information according to the second embodiment; and

FIG. 11 is a schematic diagram showing an example of a modulation method according to a modification.

### DETAILED DESCRIPTION

Hereinafter, embodiments and modifications disclosed here will be described with reference to drawings. Configurations of the embodiments and the modifications described below and operations and effects provided by the configurations are merely examples and are not limited to the following description.

### First Embodiment

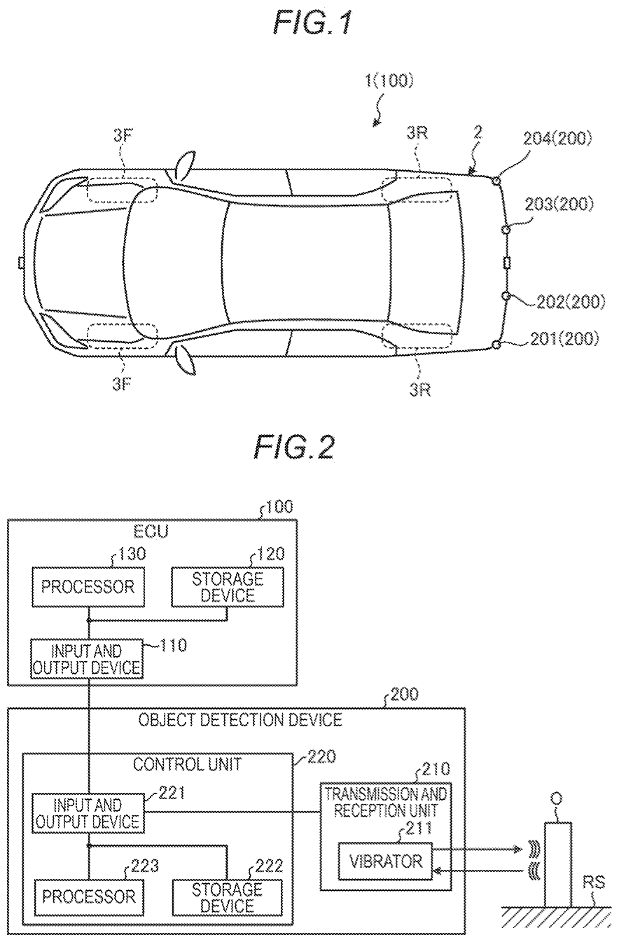

FIG. 1 is a schematic view showing an example of an appearance of a vehicle 1 including an object detection system according to a first embodiment when viewed from above.

As shown in FIG. 1, the object detection system includes an electronic control unit (ECU) 100 mounted inside the four-wheel vehicle 1 including a pair of front wheels 3F and a pair of rear wheels 3R, and object detection devices 201 to 204 mounted on an exterior of the vehicle 1.

In the example shown in FIG. 1, as an example, the object detection devices 201 to 204 are provided at different positions on, for example, a rear bumper on a rear end of a vehicle body 2 that is the exterior of the vehicle 1.

Here, in the first embodiment, hardware configurations and functions of the object detection devices 201 to 204 are the same as one another. Therefore, in the following description, the object detection devices 201 to 204 may be collectively referred to as object detection devices 200 for simplification.

In the first embodiment, setting positions of the object detection devices 200 are not limited to the example shown in FIG. 1. The object detection devices 200 may be provided, for example, on a front bumper on a front end of the vehicle body 2, on a side surface of the vehicle body 2, or on two or more of the rear bumper, the front bumper, and the side surface. In the first embodiment, the number of the object detection devices 200 is not limited to the example shown in FIG. 1. However, a technique of the first embodiment is effective in a configuration in which there are a plurality of object detection devices 200.

The object detection system according to the first embodiment performs transmission and reception of ultrasonic waves based on a configuration to be described later, and acquires a time difference or the like between the transmission and the reception, thereby detecting information related to an object (for example, an object O shown in FIG. 2 to be described later) including a person present around the object detection system.

FIG. 2 is a schematic block diagram showing an example of hardware configurations of the ECU 100 and the object detection device 200 of the object detection system according to the first embodiment.

As shown in FIG. 2, the ECU 100 has a hardware configuration similar to that of a normal computer. More specifically, the ECU 100 includes an input and output device 110, a storage device 120, and a processor 130.

The input and output device 110 is an interface for implementing transmission and reception of information between the ECU 100 and the outside (the object detection device 200 in the example shown in FIG. 1).

The storage device 120 includes a main storage device such as a read only memory (ROM) or a random access memory (RAM), and/or an auxiliary storage device such as a hard disk drive (HDD) or a solid state drive (SSD).

The processor 130 manages various processing executed by the ECU 100. The processor 130 includes an arithmetic device, for example, a central processing unit (CPU). The processor 130 reads and executes a computer program stored in the storage device 120, thereby implementing various functions, for example, parking assistance.

On the other hand, as shown in FIG. 2, the object detection device 200 includes a transmission and reception unit 210 and a control unit 220. With these configurations, the object detection device 200 is an in-vehicle sonar as an example of an in-vehicle sensor that detects a distance to an object present around the vehicle 1.

The transmission and reception unit 210 includes a vibrator 211 such as a piezoelectric element, and the transmission and reception of the ultrasonic waves are implemented by the vibrator 211.

More specifically, the transmission and reception unit 210 transmits an ultrasonic wave generated in accordance with vibration of the vibrator 211 as a transmission wave, and receives the vibration of the vibrator 211 caused by the ultrasonic wave transmitted as the transmission wave being reflected by an object present outside and returned as a reception wave. In the example shown in FIG. 2, a road surface RS and the object O provided on the road surface RS are shown as objects that can reflect the ultrasonic wave from the transmission and reception unit 210.

The example shown in FIG. 2 shows a configuration in which both the transmission of the transmission wave and the reception of the reception wave are implemented by the single transmission and reception unit 210 including the single vibrator 211. However, the technique of the first embodiment is also naturally applicable to a configuration in which a configuration on a transmission side and a configuration on a reception side are separated, for example, a configuration in which a vibrator for transmitting the transmission wave and a vibrator for receiving the reception wave are separately provided.

The control unit 220 has a hardware configuration similar to that of a normal computer. More specifically, the control unit 220 includes an input and output device 221, a storage device 222, and a processor 223.

The input and output device 221 is an interface for implementing transmission and reception of information between the control unit 220 and the outside (the ECU 100 and the transmission and reception unit 210 in the example shown in FIG. 1).

The storage device 222 includes a main storage device such as a ROM or a RAM, and/or an auxiliary storage device such as an HDD or an SSD.

The processor 223 manages various processing executed by the control unit 220. The processor 223 includes an arithmetic device, for example, a CPU. The processor 223 reads and executes a computer program stored in a storage device 333, thereby implementing various functions.

Here, the object detection device 200 according to the first embodiment detects a distance to an object as information related to the object by a technique referred to as a so-called time of flight (TOF) method. As described in detail below, the TOF method is a technique of calculating a distance to an object in consideration of a difference between a timing at which the transmission wave is transmitted (more specifically, a transmission is started) and a timing at which the reception wave is received (more specifically, a reception is started).

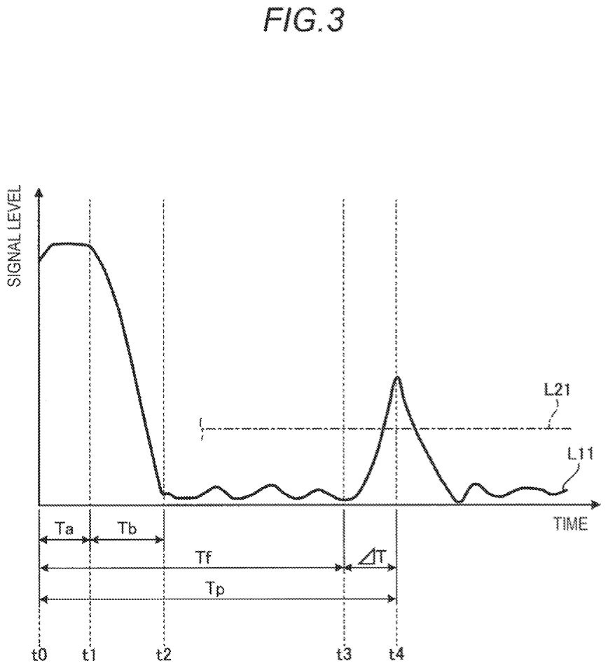

FIG. 3 is a schematic diagram showing an example of an outline of a technique used by the object detection device 200 according to the first embodiment to detect a distance to an object.

In the example shown in FIG. 3, a temporal change in a signal level (for example, amplitude) of the ultrasonic wave transmitted and received by the object detection device 200 according to the first embodiment is shown in a graph form. In the graph shown in FIG. 3, a horizontal axis corresponds to time, and a vertical axis corresponds to a signal level of a signal transmitted and received by the object detection device 200 via the transmission and reception unit 210 (the vibrator 211).

In the graph shown in FIG. 3, a solid line L11 represents an example of an envelope curve (envelope waveform) showing a temporal change in the signal level of the signal transmitted and received by the object detection device 200, that is, a vibration degree of the vibrator 211. Based on the solid line L11, it can be seen that when the vibrator 211 is driven and vibrating for time Ta from a timing t0, the transmission of the transmission wave is completed at a timing t1, and then during time Tb until a timing t2, the vibration of the vibrator 211 due to inertia continues while attenuating. Therefore, in the graph shown in FIG. 3, the time Tb corresponds to a so-called reverberation time.

The solid line L11 reaches a peak at which the vibration degree of the vibrator 211 exceeds (or equal to or more than) a predetermined threshold value Th1 shown by a dashed-dotted line L21 at a timing t4 at which time Tp elapses from the timing t0 at which the transmission of the transmission wave is started. The threshold value Th1 is a value set in advance for identifying whether the vibration of the vibrator 211 is caused by reception of a reception wave that is a transmission wave reflected by and returned from an object to be detected (for example, the object O shown in FIG. 2) or is caused by reception of a reception wave that is a transmission wave reflected by and returned from an object not to be detected (for example, the road surface RS shown in FIG. 2).

FIG. 3 shows an example in which the threshold value Th1 is set as a constant value that does not change as time elapses, and the threshold value Th1 in the first embodiment may be set as a value that changes as time elapses.

Here, the vibration having a peak exceeding (or equal to or more than) the threshold value Th1 can be considered to be caused by the reception of the reception wave that is the transmission wave reflected by and returned from the object to be detected. On the other hand, the vibration having a peak lower than (or less than) the threshold value Th1 can be considered to be caused by the reception of the reception wave that is the transmission wave reflected by and returned from the object not to be detected.

Therefore, based on the solid line L11, it can be seen that the vibration of the vibrator 211 at the timing t4 is caused by the reception of the reception wave that is the transmission wave reflected by and returned from the object to be detected.

In the solid line L11, the vibration of the vibrator 211 is attenuated after the timing t4. Therefore, the timing t4 corresponds to a timing at which the reception of the reception wave that is the transmission wave reflected by and returned from the object to be detected is completed, in other words, a timing at which the last transmission wave transmitted at the timing t1 returns as the reception wave.

Further, in the solid line L11, a timing t3 as a start point of the peak at the timing t4 corresponds to a timing at which the reception of the reception wave that is the transmission wave reflected by and returned from the object to be detected is started, in other words, a timing at which the first transmission wave transmitted at the timing t0 returns as the reception wave. Therefore, in the solid line L11, time ΔT between the timing t3 and the timing t4 is equal to the time Ta as transmission time of the transmission wave.

Based on the above description, in order to obtain a distance to the object to be detected by the TOF method, it is necessary to obtain time Tf between the timing t0 at which the transmission wave starts to be transmitted and the timing t3 at which the reception wave starts to be received. The time Tf can be obtained by subtracting the time ΔT equal to the time Ta that is the transmission time of the transmission wave from the time Tp that is a difference between the timing t0 and the timing t4 at which the signal level of the reception wave reaches the peak exceeding the threshold value Th1.

The timing t0 at which the transmission wave starts to be transmitted can be easily specified as a timing at which the object detection device 200 starts operating, and the time Ta that is the transmission time of the transmission wave is determined in advance by setting or the like. Therefore, in order to obtain the distance to the object to be detected by the TOF method, it is important to specify the timing t4 at which the signal level of the reception wave reaches the peak exceeding the threshold value Th1.

However, in the configuration in which the plurality of object detection devices 200 are provided in the embodiment described above, in order to detect information related to the object present around in more detail, transmission waves may be transmitted substantially simultaneously (simultaneously and concurrently) from each of the plurality of object detection devices 200. In this case, in order to prevent interference and the like, it is desirable to improve identifiability of the transmission waves.

Therefore, in the first embodiment, the object detection device 200 has the following configuration, thereby implementing improvement of identifiability of the transmission waves.

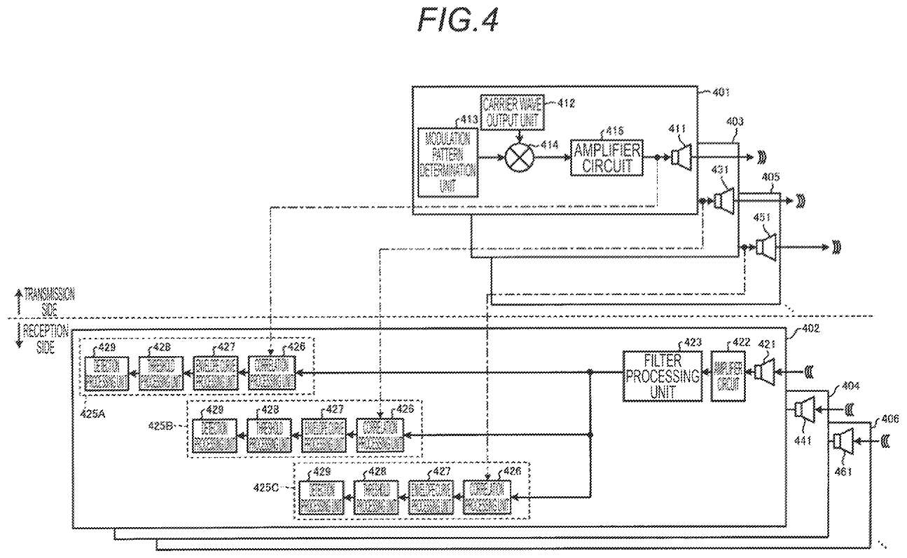

FIG. 4 is a schematic block diagram showing an example of a detailed configuration of the object detection device 200 according to the first embodiment.

As shown in FIG. 4, according to the first embodiment, a plurality of (for example, three) transmission units 401, 403, and 405 are provided as a configuration on the transmission side, and a plurality of (for example, three) reception units 402, 404, and 406 are provided as a configuration on the reception side.

Here, in FIG. 4, the configuration on the transmission side and the configuration on the reception side are shown in a separated state, and such a form shown in the drawings is merely for convenience of description. Therefore, in the example shown in FIG. 4, for example, a combination of the transmission unit 401 and the reception unit 402, a combination of the transmission unit 403 and the reception unit 404, and a combination of the transmission unit 405 and the reception unit 406 separately constitute one object detection device 200. However, as described above, the technique of the first embodiment is also naturally applicable to the configuration in which the configuration on the transmission side and the configuration on the reception side are separated from each other.

FIG. 4 shows three configurations on the transmission side and three configurations on the reception side, and one configuration on the transmission side and one configuration on the reception side may be further provided in the first embodiment to correspond to the four object detection devices 200 shown in FIG. 1.

In the first embodiment, at least a part of the configurations shown in FIG. 4 may be implemented as a result of cooperation between hardware and software, more specifically, as a result of the processor 223 of the object detection device 200 reading the computer program from the storage device 222 and executing the computer program. However, in the embodiment, at least a part of the configurations shown in FIG. 4 may be implemented by dedicated hardware (circuitry).

First, the configuration of the transmission side of the object detection device 200 will be described.

As shown in FIG. 4, the transmission unit 401 includes a wave transmitter 411, a carrier wave output unit 412, a modulation pattern determination unit 413, a multiplier 414, and an amplifier circuit 415.

The transmission units 403 and 405 include wave transmitters 431 and 451 similar to the wave transmitter 411, respectively. In FIG. 4, although illustration other than the wave transmitters 431 and 451 is omitted for convenience of space, the transmission units 403 and 405 have similar configurations as the transmission unit 401 in addition to the wave transmitters 431 and 451.

The wave transmitter 411 includes the above-described vibrator 211, and the vibrator 211 transmits a transmission wave corresponding to a transmission signal (after amplification) output from the amplifier circuit 415.

Here, in the first embodiment, the wave transmitter 411 is configured to transmit, for example, under control of the ECU 100, a transmission wave substantially simultaneously with the wave transmitters 431 and 451 of the other object detection devices 200. Therefore, in the first embodiment, it is necessary to assign identification information to the transmission wave so that a transmission source of the transmission wave returned as the reception wave can be specified.

Therefore, in the first embodiment, a carrier wave such as a sine wave is modulated based on a modulation pattern corresponding to identification information to be assigned to a transmission wave, and thereby a transmission wave encoded to include the identification information is generated.

More specifically, the carrier wave output unit 412 outputs a carrier wave, such as the sine wave, which is a source of the transmission wave. Then, the modulation pattern determination unit 413 determines a modulation pattern of the carrier wave corresponding to identification information including a code of a bit string including a sequence of, for example, 0 or 1 bits to be assigned to the transmission wave. Then, the multiplier 414 modulates the carrier wave by multiplying an output from the modulation pattern determination unit 413 by an output from the carrier wave output unit 412, and generates a transmission wave encoded to include the identification information.

In the first embodiment, a code length of the identification information is set such that at least four object detection devices 200 can be identified from one another in the configuration in which four object detection devices 200 are provided as shown in FIG. 1.

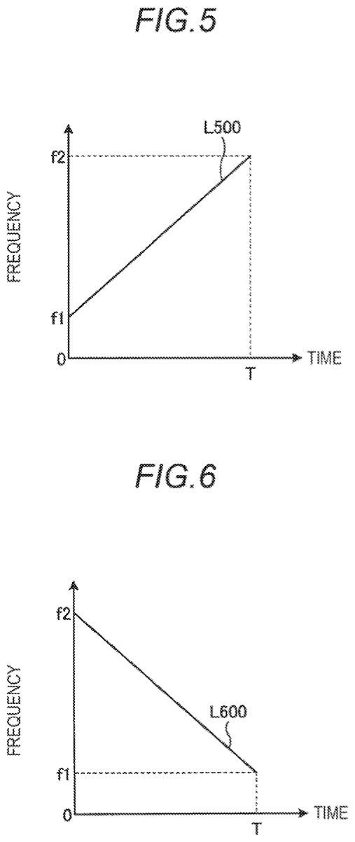

In the first embodiment, the modulation pattern of the carrier wave is determined using a plurality of (for example, two) chirp signals different from one another as shown in FIGS. 5 and 6 below.

FIG. 5 is a schematic diagram showing an example of a first chirp signal according to the first embodiment. FIG. 6 is a schematic diagram showing an example of a second chirp signal according to the first embodiment.

As shown in FIG. 5, the first chirp signal is a signal in which a frequency monotonously (more specifically, linearly) increases from f1 to f2 in a predetermined period T (see a solid line L500). As shown in FIG. 6, the second chirp signal is a signal in which a frequency monotonously (more specifically, linearly) decreases from f2 to f1 in the predetermined period T (see a solid line L600).

Here, in the first embodiment, the transmission wave encoded to include the identification information is generated based on a combination of two or more surges of a first surge that is a carrier wave for the period T in which a frequency modulation based on the first chirp signal is performed and a second surge that is a carrier wave for the period T in which a frequency modulation based on the second chirp signal is performed.

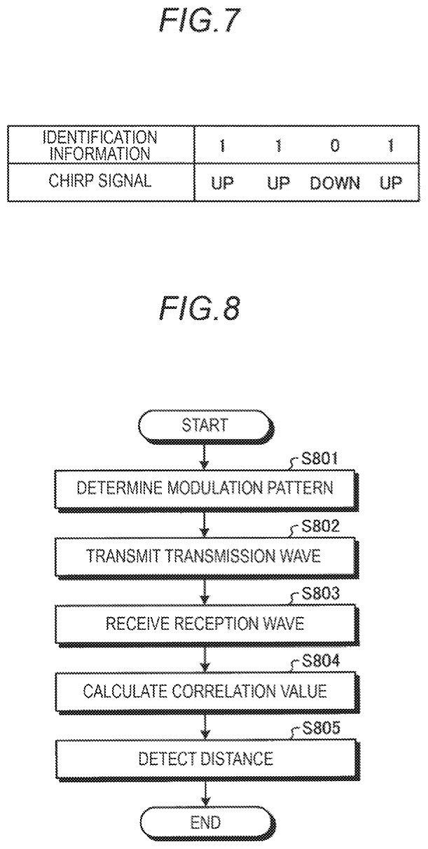

For example, in the first embodiment, a bit “1” is assigned to the first surge and a bit “0” is assigned to the second surge. In this case, for example, the transmission wave encoded to include the identification information including the code of a bit string “1101” is generated by modulating the carrier wave based on a modulation pattern as shown in FIG. 7.

FIG. 7 is a schematic diagram showing an example of the modulation pattern corresponding to the identification information according to the first embodiment.

In the example shown in FIG. 7, “UP” indicates the first chirp signal in which the frequency monotonically increases and “DOWN” indicates the second chirp signal in which the frequency monotonically decreases. In the example shown in FIG. 7, as described above, the bit “1” is assigned to the first surge applied with the frequency modulation based on the first chirp signal and the bit “0” is assigned to the second surge applied with the frequency modulation based on the second chirp signal.

In view of the above description, as shown in FIG. 7, the transmission wave encoded to include the identification information including the code of the bit string “1101” is obtained by combining, in the following order, four waves of the first surge based on the first chirp signal (“UP”), the first surge based on the first chirp signal (“UP”), the second surge based on the second chirp signal (“DOWN”), and the first surge based on the first chirp signal (“UP”).

Therefore, in the first embodiment, when the identification information to be assigned to the transmission wave is determined as the code of the bit string “1101”, the modulation pattern determining unit 413 determines, as the modulation pattern of the carrier wave, a pattern in which four frequency modulations of a frequency modulation based on the first chirp signal, a frequency modulation based on the first chirp signal, a frequency modulation based on the second chirp signal, and a frequency modulation based on the first chirp signal are sequentially executed in the above order.

Referring back to FIG. 4, the amplifier circuit 415 amplifies the transmission signal output from the multiplier 414 and outputs the amplified transmission signal to the wave transmitter 411. In this manner, the configuration of the transmission side of the object detection device 200 in the first embodiment transmits transmission waves encoded based on a combination of two or more surges of two surges that are different from those of the other object detection device 200, in which a frequency modulation based on two chirp signals in a pattern having different frequencies is applied to the two surges.

Next, the configuration of the reception side of the object detection device 200 will be described.

As shown in FIG. 4, the reception unit 402 includes a wave receiver 421, an amplifier circuit 422, a filter processing unit 423, an identification unit 424, and a plurality of (for example, three) signal processing systems 425A to 425C.

The reception units 404 and 406 include wave receivers 441 and 461 similar to the wave receiver 421, respectively. In FIG. 4, although illustration other than the wave receivers 441 and 461 is omitted for convenience of space, the reception units 404 and 406 have the similar configuration as the reception unit 402 in addition to the wave receivers 441 and 461.

The wave receiver 421 includes the above-described vibrator 211. The vibrator 211 receives the transmission wave reflected by the object as the reception wave.

The amplifier circuit 422 amplifies a reception signal that is a signal corresponding to the reception wave received by the wave receiver 421.

The filter processing unit 423 performs filtering processing on the reception signal amplified by the amplifier circuit 422. The filtering processing includes prevention of noise, correction of Doppler shift, and the like.

Here, in the first embodiment as described above, a plurality of transmission waves are transmitted substantially simultaneously from the plurality of wave transmitters 411, 431, and 451. Therefore, the reception wave received by the wave receiver 421 is obtained by at least superimposing a part of a plurality of surges corresponding to a plurality of transmission waves transmitted from the plurality of wave transmitters 411, 431, and 451.

Therefore, in the first embodiment, the same number of signal processing systems 425A to 425C as the number of wave transmitters 411, 431, and 451 are provided. Each of the signal processing systems 425A to 425C includes a correlation processing unit 426, an envelope curve processing unit 427, a threshold processing unit 428, and a detection processing unit 429. Based on these configurations, the signal processing systems 425A to 425C achieve a function of specifying a relationship between a reception wave received via the wave receiver 421 and a plurality of transmission waves transmitted via the wave transmitters 411, 431, and 451, and a function of detecting information related to an object based on the specified relationship.

Then, the correlation processing unit 426 acquires a correlation value corresponding to a similarity between the identification information of the transmission wave and the reception wave based on the transmission signals acquired from the configuration on the transmission side and the reception signal subjected to the filtering processing by the filter processing unit 423. The correlation value is calculated based on a generally well-known correlation function or the like.

Then, the envelope curve processing unit 427 obtains an envelope curve of a signal waveform corresponding to the correlation value acquired by the correlation processing unit 426.

Then, the threshold processing unit 428 compares the value of the envelope curve obtained by the envelope curve processing unit 427 with a predetermined threshold value, and determines whether the identification information of the transmission wave and the identification information of the reception wave are similar to each other at a predetermined level or more based on a comparison result.

Then, based on a processing result by the threshold processing unit 428, the detection processing unit 429 specifies a timing at which the similarity between the identification information of the transmission wave and the reception wave is at a predetermined level or more, that is, a timing (for example, the timing t4 shown in FIG. 2) at which the signal level of the reception wave that is the transmission wave returned by reflection reaches a peak exceeding the threshold value, and detects the distance to the object as the information related to the object by the TOF method.

Here, in the first embodiment, the correlation processing unit 426 of the signal processing system 425A is configured to acquire a correlation value using the transmission signal acquired from the transmission unit 401. Therefore, the correlation value acquired by the correlation processing unit 426 of the signal processing system 425A is a value reflecting the similarity to the transmission wave transmitted from the wave transmitter 411.

Similarly, the correlation processing unit 426 of the signal processing system 425B is configured to acquire a correlation value using the transmission signal acquired from the transmission unit 403, and the correlation processing unit 426 of the signal processing system 425C is configured to acquire a correlation value using the transmission signal acquired from the transmission unit 405. Therefore, the correlation value acquired by the correlation processing unit 426 of the signal processing system 425B is a value reflecting a similarity to the transmission wave transmitted from the wave transmitter 431, and the correlation value acquired by the correlation processing unit 426 of the signal processing system 425C is a value reflecting a similarity to the transmission wave transmitted from the wave transmitter 451.

Therefore, in the first embodiment, the detection processing unit 429 of the signal processing system 425A specifies a timing at which the signal level of the reception wave received by the wave receiver 421 due to the transmission wave transmitted from the wave transmitter 411 returning by reflection reaches the peak exceeding the threshold value. The detection processing unit 429 of the signal processing system 425B specifies a timing at which the signal level of the reception wave received by the wave receiver 421 due to the transmission from the wave transmitter 431 returning by reflection reaches the peak exceeding the threshold value, and the detection processing unit 429 of the signal processing system 425C specifies a timing at which the signal level of the reception wave received by the wave receiver 421 due to the transmission from the wave transmitter 451 returning by reflection reaches the peak exceeding the threshold value.

Accordingly, in the first embodiment, by using the three signal processing systems 425A to 425C, the timing of reception by the wave receiver 421 due to the transmission wave transmitted from the wave transmitter 411 returning by reflection, the timing of reception by the wave receiver 421 due to the transmission wave transmitted from the wave transmitter 431 returning by reflection, and the timing of reception by the wave receiver 421 due to the transmission wave transmitted from the wave transmitter 451 returning by reflection can be specified appropriately. Then, based on the difference of the timings of the transmission and the receptions, the distance to the object can be detected appropriately.

Based on the above configuration, the object detection system according to the first embodiment detects the information related to the object by executing a flow of processing as shown in FIG. 8 next.

FIG. 8 is a schematic flowchart showing an example of a series of processing performed by the object detection system according to the first embodiment to detect the distance to the object.

As shown in FIG. 8, in the first embodiment, first, in S801, in each object detection device 200 of the object detection system, the modulation pattern determination unit 413 determines a modulation pattern of the carrier wave corresponding to the identification information to be assigned to the transmission wave.

Then, in S802, in each object detection device 200, the transmission and reception unit 210 transmits the transmission wave generated by modulating the carrier wave base on the modulation pattern determined in S801.

Then, in S803, in each object detection device 200, the transmission and reception unit 210 receives the reception wave as a result of the transmitted wave transmitted in S802 being returned by the reflection by the object.

Then, in S804, in each object detection device 200, the correlation processing unit 426 acquires the correlation value corresponding to the similarity between the identification information of the transmission wave and the reception wave.

Then, in S805, in each object detection device 200, the detection processing unit 829 detects the distance to the object based on the comparison result of (the envelope curve of) the correlation value obtained in S804 with the predetermined threshold value. Then, the processing ends.

As described above, the object detection system according to the first embodiment includes a plurality of object detection devices 200. Each of the plurality of object detection devices 200 has the same configuration.

For example, in the first embodiment, one of the plurality of object detection devices 200 includes the transmission unit 401, the reception unit 402, and the detection processing unit 429. The transmission unit 401 transmits, substantially simultaneously with the other object detection devices 200, a transmission wave encoded based on a combination of two or more surges of a plurality of surges that are different from those of the other object detection devices 200, in which a frequency modulation based on a plurality of chirp signals whose frequencies change in different patterns is performed on the plurality of surges. The reception unit 402 receives a reception wave that is the transmission wave returned in response to reflection by an object. The detection processing unit 429 detects information related to the object based on information acquired as a result of transmission and reception of the transmission wave and the reception wave.

According to the configuration, it is possible to transmit the transmission wave encoded to include appropriate identification information based on a combination of two or more surges of a plurality of surges, in which a frequency modulation based on a plurality of chirp signals whose frequencies change in different patterns is performed on the plurality of surges. Therefore, the identifiability of the transmission waves can be improved.

More specifically, in the first embodiment, the plurality of chirp signals described above include a first chirp signal whose frequency monotonically increases (see FIG. 5) and a second chirp signal whose frequency monotonically decreases (see FIG. 6). According to such a configuration, by two chirp signals of a simple waveform, the identifiability of the transmission waves can be simply improved.

In the first embodiment, the object detection device 200 further includes the correlation processing unit 426 that acquires a correlation value indicating a similarity between the transmission wave and the reception wave. The detection processing unit 429 detects the information related to the object based on the comparison result of the correlation value and the threshold value. According to such a configuration, by using the correlation value, the information related to the object can be detected with high accuracy.

In the first embodiment, the detection processing unit 429 detects a distance to the object as the information related to the object based on a difference between the timing at which the transmission wave is transmitted and the timing at which the reception wave is received. According to such a configuration, information that is useful as the distance to the object is obtained as the information related to the object.

### Second Embodiment

In the first embodiment described above, the carrier wave is modulated based on the modulation pattern using the frequency modulation based on the plurality of chirp signals, and thereby the identifiability of the transmission waves is improved. However, the second embodiment considers a configuration in which the identifiability of the transmission waves can be improved by further modulating the carrier wave with a modulation pattern using a phase modulation while using the frequency modulation based on the single chirp signal.

A hardware configuration and a functional configuration of the object detection system according to the second embodiment are basically similar as those according to the first embodiment described above. However, in the second embodiment, a modulation pattern determination unit 413a (see FIG. 4) determines the modulation pattern of the carrier wave by a method different from that in the first embodiment described above.

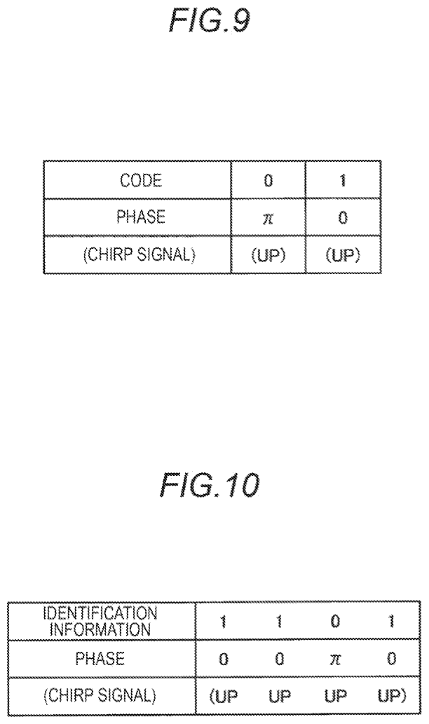

FIG. 9 is a schematic diagram showing an example of a modulation method according to the second embodiment.

As shown in FIG. 9, in the second embodiment, the transmission wave is generated by a combination of two or more surges of a plurality of surges to which the frequency modulation based on the single chirp signal whose frequency changes in a predetermined pattern is applied, and to which the phase modulation is applied to assign phases different from one another. Each of the plurality of surges mentioned here corresponds to the carrier wave for the period T shown in FIG. 5.

For example, in the example shown in FIG. 9, the code of the bit “0” is assigned to a third surge that has been applied with the frequency modulation based on the first chirp signal that monotonically increases during the period T and that has been applied with the phase modulation to assign a phase “π”, and the code of the bit “1” is assigned to a fourth surge that has been applied with the frequency modulation based on the first chirp signal and has been applied with the phase modulation to assign a phase “0”. In this case, for example, the transmission wave encoded to include identification information including the code of a bit string “1101” is generated by modulating the carrier wave based on a modulation pattern as shown in FIG. 10.

FIG. 10 is a schematic diagram showing an example of the modulation pattern corresponding to the identification information according to the second embodiment.

As shown in FIG. 10, in the second embodiment, the transmission wave encoded to include the identification information including the code of the bit string “1101” is obtained by combining, in the following order, four surges of the fourth surge described above to which the phase “0” is assigned, the fourth surge described above to which the phase “0” is assigned, the third surge described above to which the phase “π ” is assigned, and the fourth surge described above to which the phase “0” is assigned.

Therefore, in the second embodiment, when the identification information to be assigned to the transmission wave is determined as the code of the bit string “1101”, the modulation pattern determining unit 413a determines, as the modulation pattern of the carrier wave, a pattern in which a combination of the frequency modulation based on the first chirp signal and the phase modulation of assigning the phase “0”, a combination of the frequency modulation based on the first chirp signal and the phase modulation of assigning the phase “0”, a combination of the frequency modulation based on the first chirp signal and the phase modulation of assigning the phase “π”, and a combination of the frequency modulation based on the first chirp signal and the phase modulation of assigning the phase “0” are sequentially executed in the above order.

As described above, the object detection system according to the second embodiment basically has a similar configuration as that of the first embodiment described above. However, in the second embodiment, which is different from the first embodiment, the transmission wave to be transmitted is encoded based on a combination of two or more surges of the plurality of surges to which the frequency modulation based on the single chirp signal whose frequency changes in a predetermined pattern is applied, and to which the phase modulation is applied to assign phases different from one another.

The above-described configuration can transmit the transmission waves encoded to include appropriate identification information based on a combination of two or more surges of a plurality of surges to which the frequency modulation based on a single chirp signal whose frequency changes in a predetermined pattern is applied, and to which the phase modulation is applied to assign phases different from one another. Therefore, according to the second embodiment, similar to the first embodiment described above, the identifiability of the transmission waves can be improved.

Other effects according to the second embodiment are similar to those of the first embodiment.

### Modification

In the two embodiments described above, the technique disclosed here is applied to a configuration in which the information related to the object is detected by transmission and reception of ultrasonic waves. Alternatively, the technique disclosed here can also be applied to a configuration in which information related to an object is detected by transmission and reception of sound waves, millimeter waves, electromagnetic waves, or the like as surges other than the ultrasonic waves.

The two embodiments described above describe a configuration in which the distance to the object is detected as the information related to the object. Alternatively, the technique disclosed here can also be applied to a configuration in which only presence or absence of the object is detected as the information related to the object.

The first embodiment described above describes a technique in which a transmission wave is generated by a combination of two or more surges (the first surge and the second surge) applied with frequency modulation based on the two chirp signals. However, the technique disclosed here also includes a technology of performing frequency modulation using three or more chirp signals whose frequencies change in patterns different from one another. The technique disclosed here also includes a technology of generating a transmission wave using one of a plurality of surges applied with frequency modulations based on a plurality of chirp signals.

Similarly, the second embodiment described above describes a technique in which a transmission wave is generated by a combination of two or more surges (the third surge and the fourth surge) applied with the frequency modulation based on the simple chirp signal and applied with the phase modulations to assign two phases different from one another. However, the technique disclosed here also includes a technique in which, a transmission wave is generated by a combination of two or more surges of three or more surges applied with the frequency modulation based on the simple chirp signal and applied with the phase modulations to assign three or more phases different from one another. The technique disclosed here also includes a technique in which, a transmission wave is generated using one of a plurality of surges applied with the frequency modulation based on the simple chirp signal and applied with the phase modulations such that phases different from one another are assigned.

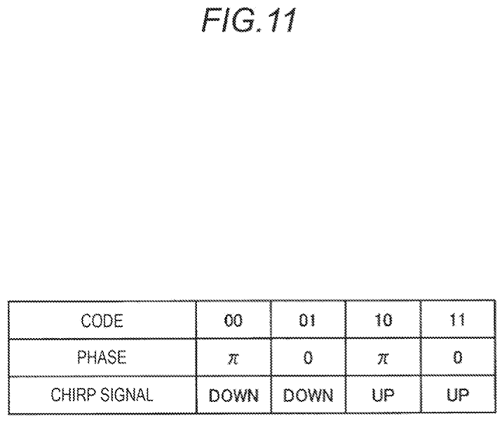

The technique disclosed here is also applicable to a technique combining the two embodiments described above as shown in FIG. 11.

FIG. 11 is a schematic diagram showing an example of the modulation method according to the modification.

As shown in FIG. 11, in the modification, the transmission wave is generated by one or a combination of two or more surges of the plurality of surges which are applied with the frequency modulations based on the plurality of chirp signals similar to that in the first embodiment and applied with the phase modulations such that phases different from one another are assigned similar to that in the second embodiment. Each of the plurality of surges mentioned here corresponds to the carrier wave in the period T shown in FIGS. 5 and 6.

For example, in the example shown in FIG. 11, a code of the bit string “00” is assigned to a fifth surge that has been applied with the frequency modulation based on the second chirp signal that monotonically decreases during the period T and that has been applied with the phase modulation to assign the phase “π”. A code of the bit string “01” is assigned to a sixth surge that has been applied with the frequency modulation based on the second chirp signal and that has been applied with the phase modulation to assign the phase “0”.

In the example shown in FIG. 11, a code of the bit string “10” is assigned to a seventh surge that has been applied with the frequency modulation based on the first chirp signal that monotonically increases during the period T and that has been applied with the phase modulation to assign the phase “π”. A code of the bit string “11” is assigned to an eighth surge that has been applied with the frequency modulation based on the first chirp signal and that has been applied with the phase modulation to assign the phase “0”.

According to the modification example shown in FIG. 11, by using both the encoding based on the frequency modulation and the encoding based on the phase modulation, the number of representable codes increases and thereby the identifiability of the transmission waves can be further improved.

An object detection system as an example of this disclosure includes: a plurality of object detection devices, in which each of the plurality of object detection devices includes a transmission unit that transmits, substantially simultaneously with the other object detection devices, a transmission wave encoded based on one or a combination of two or more surges of a plurality of surges which are respectively applied with frequency modulations based on a plurality of chirp signals whose frequencies change in patterns different from one another, the one or the combination of two or more surges being different from those used in the other object detection devices, a reception unit that receives a reception wave that is the transmission wave returned in response to reflection by an object, and a detection processing unit that detects information related to the object based on information acquired as a result of transmission and reception of the transmission wave and the reception wave.

According to the object detection system described above, it is possible to transmit the transmission wave encoded to include appropriate identification information based on one or a combination of two or more surges of the plurality of surges which are respectively applied with frequency modulations based on a plurality of chirp signals whose frequencies change in patterns different from one another. Therefore, the identifiability of the transmission waves can be improved.

In the object detection system described above, the transmission unit may transmit, substantially simultaneously with the other object detection devices, the transmission wave encoded based on one or a combination of two or more surges of a plurality of surges which are applied with the frequency modulations based on the plurality of chirp signals and applied with phase modulations such that phases different from one another are assigned, the one or the combination of two or more surges being different from those used in the other object detection devices. According to such a configuration, by using the phase modulation together, the number of representable codes increases and thereby the identifiability of the transmission waves can be further improved.

In the object detection system described above, the plurality of chirp signals may include a first chirp signal whose frequency monotonically increases and a second chirp signal whose frequency monotonically decreases. According to such a configuration, by two chirp signals of a simple waveform, the identifiability of the transmission waves can be simply improved.

The object detection system described above may further include a correlation processing unit that acquires a correlation value indicating a similarity between the transmission wave and the reception wave, in which the detection processing unit may detect the information related to the object based on a comparison result of the correlation value and a threshold value. According to such a configuration, by using the correlation value, the information related to the object can be detected with high accuracy.

In the object detection system described above, the detection processing unit may detect, as the information related to the object, a distance to the object based on a difference between a timing at which the transmission wave is transmitted and a timing at which the reception wave is received. According to such a configuration, information that is useful as the distance to the object can be obtained as the information related to the object.

An object detection system as another example of this disclosure includes a plurality of object detection devices, in which each of the plurality of object detection devices includes a transmission unit that transmits, substantially simultaneously with the other object detection devices, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from those used in the other object detection devices, a reception unit that receives a reception wave that is the transmission wave returned in response to reflection by an object, and a detection processing unit that detects information related to the object based on information acquired as a result of transmission and reception of the transmission wave and the reception wave.

According to the object detection system described above, it is possible to transmit the transmission waves encoded to include appropriate identification information based on one or a combination of two or more surges of the plurality of surges which are applied with the frequency modulation based on a single chirp signal whose frequency changes in a predetermined pattern and applied with the phase modulations such that phases different from one another are assigned. Therefore, the identifiability of the transmission waves can be improved.

In the object detection system described above, the predetermined pattern of the single chirp signal may be a pattern in which a frequency monotonically increases or decreases. According to such a configuration, by two chirp signals of a simple waveform, the identifiability of the transmission waves can be simply improved.

The object detection system described above may further include: a correlation processing unit that acquires a correlation value indicating a similarity between the transmission wave and the reception wave, in which the detection processing unit may detect the information related to the object based on a comparison result of the correlation value and a threshold value. According to such a configuration, by using the correlation value, the information related to the object can be detected with high accuracy.

In the object detection system described above, the detection processing unit may detect, as the information related to the object, a distance to the object based on a difference between a timing at which the transmission wave is transmitted and a timing at which the reception wave is received. According to such a configuration, information that is useful as the distance to the object can be obtained as the information related to the object.

An object detection device as another example of this disclosure includes: a transmission unit that transmits, substantially simultaneously with another object detection device, a transmission wave encoded based on one or a combination of two or more surges of a plurality of surges which are respectively applied with frequency modulations based on a plurality of chirp signals whose frequencies change in patterns different from one another, the one or the combination of two or more surges being different from that used in the another object detection device, a reception unit that receives a reception wave that is the transmission wave returned in response to reflection by an object, and a detection processing unit that detects information related to the object based on information acquired as a result of transmission and reception of the transmission wave and the reception wave.

According to the object detection device described above, it is possible to transmit the transmission wave encoded to include appropriate identification information based on one or a combination of two or more surges of the plurality of surges which are respectively applied with frequency modulations based on a plurality of chirp signals whose frequencies change in patterns different from one another. Therefore, the identifiability of the transmission waves can be improved.

An object detection device as another example of this disclosure includes: a transmission unit that transmits, substantially simultaneously with another object detection device, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from that used in the another object detection device, a reception unit that receives a reception wave that is the transmission wave returned in response to reflection by an object, and a detection processing unit that detects information related to the object based on information acquired as a result of transmission and reception of the transmission wave and the reception wave.

According to the object detection device described above, it is possible to transmit the transmission wave encoded to include appropriate identification information based on one or a combination of two or more surges of the plurality of surges which are applied with the frequency modulation based on a single chirp signal whose frequency changes in a predetermined pattern and applied with the phase modulations such that phases different from one another are assigned. Therefore, the identifiability of the transmission waves can be improved.

While embodiments and modifications disclosed here have been described, these embodiments and modifications have been described by way of example only, and are not intended to limit the scope of the disclosure. These novel embodiments and modifications may be implemented in a variety of forms and various omissions, substitutions and changes may be made without departing from the spirit of the disclosure. These embodiments and modifications are covered by the scope and spirit of the disclosure, and are covered in the equivalent range with the inventions described in the scope of the claims.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An object detection system comprising:
a plurality of object detection devices, wherein
each of the plurality of object detection devices includes
a transmission unit that transmits, substantially simultaneously with the other object detection devices, a transmission wave encoded based on one or a combination of two or more surges of a plurality of surges which are respectively applied with frequency modulations based on a plurality of chirp signals whose frequencies change in patterns different from one another, the one or the combination of two or more surges being different from those used in the other object detection devices,
a reception unit that receives a reception wave that is the transmission wave returned in response to reflection by an object, and
a detection processing unit that detects information related to the object based on information acquired as a result of transmission and reception of the transmission wave and the reception wave.

2. The object detection system according to claim 1, wherein
the transmission unit transmits, substantially simultaneously with the other object detection devices, the transmission wave encoded based on one or a combination of two or more surges of a plurality of surges which are applied with the frequency modulations based on the plurality of chirp signals and applied with phase modulations such that phases different from one another are assigned, the one or the combination of two or more surges being different from those used in the other object detection devices.

3. The object detection system according to claim 1, wherein
the plurality of chirp signals include a first chirp signal whose frequency monotonically increases and a second chirp signal whose frequency monotonically decreases.

4. The object detection system according to claim 1, further comprising:
a correlation processing unit that acquires a correlation value indicating a similarity between the transmission wave and the reception wave, wherein
the detection processing unit detects the information related to the object based on a comparison result of the correlation value and a threshold value.

5. The object detection system according to claim 1, wherein
the detection processing unit detects, as the information related to the object, a distance to the object based on a difference between a timing at which the transmission wave is transmitted and a timing at which the reception wave is received.

6. An object detection system comprising:
a plurality of object detection devices, wherein
each of the plurality of object detection devices includes
a transmission unit that transmits, substantially simultaneously with the other object detection devices, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from those used in the other object detection devices,
a reception unit that receives a reception wave that is the transmission wave returned in response to reflection by an object, and
a detection processing unit that detects information related to the object based on information acquired as a result of transmission and reception of the transmission wave and the reception wave.

7. The object detection system according to claim 6, wherein
the predetermined pattern of the single chirp signal is a pattern in which a frequency monotonically increases or decreases.

8. The object detection system according to claim 6, further comprising:
a correlation processing unit that acquires a correlation value indicating a similarity between the transmission wave and the reception wave, wherein
the detection processing unit detects the information related to the object based on a comparison result of the correlation value and a threshold value.

9. The object detection system according to claim 6, wherein
the detection processing unit detects, as the information related to the object, a distance to the object based on a difference between a timing at which the transmission wave is transmitted and a timing at which the reception wave is received.

10. An object detection device comprising:
a transmission unit that transmits, substantially simultaneously with another object detection device, a transmission wave encoded based on one or a combination of two or more surges of a plurality of surges which are respectively applied with frequency modulations based on a plurality of chirp signals whose frequencies change in patterns different from one another, the one or the combination of two or more surges being different from that used in the another object detection device,
a reception unit that receives a reception wave that is the transmission wave returned in response to reflection by an object, and
a detection processing unit that detects information related to the object based on information acquired as a result of transmission and reception of the transmission wave and the reception wave.

11. An object detection device comprising:
a transmission unit that transmits, substantially simultaneously with another object detection device, a transmission wave encoded based on one or a combination of two or more surges of a plurality of surges which are applied with a frequency modulation based on a single chirp signal whose frequency changes in a predetermined pattern and applied with phase modulations such that phases different from one another are assigned, the one or the combination of two or more surges being different from that used in the another object detection device,
a reception unit that receives a reception wave that is the transmission wave returned in response to reflection by an object, and
a detection processing unit that detects information related to the object based on information acquired as a result of transmission and reception of the transmission wave and the reception wave.
